(19) United States
(12) Patent Application Publication
(10) Pub. No.: US 2006/0267438 A1
(43) Pub. Date: Nov. 30, 2006

(54) Rotor winding

(76) Inventor: Adrian Amariei, Maple (CA)

Correspondence Address: David B. Woycechowsky;ELECTROVAYA PATENT DEPARTMENT, 2645 Royal Windsor Drive, Mississauga, ON, L5J 1K9, CA

(21) Appl. No.: 11/369,021

(22) Filed: Mar. 7, 2006

Related U.S. Application Data
(60) Provisional application No. 60/658,600, filed on Mar. 7, 2005.

(51) Int. Cl. H02K 1/00; H02K 3/00

(52) U.S. Cl. 310/179

(57) ABSTRACT

Rotor winding assembly for a rotary electric motor, wherein the rotor winding has a V-shaped pattern, instead of a conventional H-shaped pattern. The V-shaped pattern makes it easier to magnetically and/or mechanically balance odd-polarity rotor windings.

### RELATED APPLICATION DATA

This application claims any and all applicable benefits based on the following provisional patent application: U.S. patent application No. 60/658,600 filed on 7 Mar. 2005 and entitled Rotor Winding. All of the foregoing patent-related documents are herein incorporated by reference.

### FIELD OF THE INVENTION

The present invention relates to electric motors and generators, and more particularly to brush electric motors having rotors wound with magnet wire.

### DESCRIPTION OF THE RELATED ART

It is conventional to have a brush electric motor including a stator and a rotor, with the magnet being wound with magnet wire. More particularly, long magnet wire is wound repeatedly around winding support regions of the rotor, located circumferentially between poles of the rotor, according to a winding pattern. Generally, these motors also include a commutator, which conducts electric current from the brush to the magnet wire by contact between the brush and the commutator. There are various ways to construct the rotor and various winding patterns.

For example, some rotors are constructed to have an even number of poles and a correspondingly even number of winding support regions, circumferentially located around the rotor. One winding pattern that can be used with an even-pole rotor is the H-pattern. FIG. 1 shows a schematic of an H-pattern winding 50. In the H-pattern, pairs of consecutive windings are wound to be generally parallel to each other. These parallel pairs are formed by choosing two sets of two winding support regions so that: (1) the two winding support regions of each pair are approximately (but generally not exactly) circumferentially opposite of each other; (2) each set of two winding support regions of the pair is characterized by an angular distance between the two winding support regions; and (3) the angular distance of the two sets of winding support regions of the pair are approximately (eg, exactly) equal. H-patterns are difficult or impossible to use with rotors that have an odd number of poles.

U.S. published patent application 2002/0096966 (“Jordan”) discloses an electric motor including a rotor and a rotor winding disposed on the rotor. Because Jordan does not focus on its rotor winding pattern, it is difficult to tell what the Jordan rotor winding pattern is. However, it is believed that Jordan's rotor is wound with single loops of coil, and is not wound repeatedly with a unitary piece of magnet wire.

U.S. published patent application 2003/0030333 (“Johnsen”) discloses a brushless electric motor. The Johnsen motor probably has an H-pattern winding (see FIG. 3 of Johnsen), but it is difficult to tell for sure because Johnsen does not include a complete description of its winding pattern. For what it is worth, Johnsen does state that “a main field winding 52 extends axially along recesses 54” and “(t)he winding 52 comprises a plurality of coils of wire, forming poles.”

Description Of the Related Art Section Disclaimer: To the extent that specific publications are discussed above in this Background section, these discussions should not be taken as an admission that the discussed publications (e.g., patents) are prior art for patent law purposes. For example, some or all of the discussed publications may not be sufficiently early in time, may not reflect subject matter developed early enough in time and/or may not be sufficiently enabling so as to amount to prior art for patent law purposes.

### SUMMARY OF THE INVENTION

The present invention involves a rotor winding assembly with an odd number of poles and/or a rotor winding assembly with a V-shaped winding pattern (see DEFINITIONS section for definition of V-shaped winding pattern.

Various embodiments of the present invention may exhibit one or more of the following objects, features and/or advantages:

(1) V-shaped winding pattern facilitates a mechanically balanced winding assembly, which is less susceptible to imbalance problems, such as mechanical vibration. This is especially important for high rotational speed (e.g., 8000 rotations per minute (rpm)) motors and generators.

(2) V-shaped winding pattern tends to lead to angles (that is, non-normal angles) between the respective directions of the magnetic field of the stator and the magnetic field of the windings of the rotor. Therefore, these angles can help drive the rotor into motion, accelerate the rotation of the rotor and/or maintain the rotor in rotational motion.

(3) A V-shaped winding allows the magnet wire of the winding to grow up symmetrically. In other words, the V-shaped winding increases favorable magnetically-induced moment forces on the rotor, but decreases unfavorable moment forces caused by imbalances of mass in the rotating rotor winding assembly.

(4) An odd number of poles also tends to lead to magnetically induced moment forces and/or angles (that is, non-normal angles) between the respective directions of the magnetic field of the stator and the magnetic field of the windings of the rotor. Therefore, an odd number of poles can help drive the rotor into motion, accelerate the rotation of the rotor and/or maintain the rotor in rotational motion.

(5) Improves cost efficiency, ease of assembly, simplicity and/or performance of the rotor winding assembly.

### BRIEF DESCRIPTION OF THE DRAWINGS

FIG. 1 is a schematic view of a prior art H-shaped rotor winding pattern;

FIG. 2 is a side orthographic view of a first embodiment of a rotor according to the present invention;

FIG. 3 is a top orthographic view of the first embodiment rotor;

FIG. 4 is a side view of an electric rotary motor according to the present invention;

FIG. 5 is a perspective view of a portion of a rotary winding in an electric motor according to the present invention;

FIG. 6 is a schematic view of a first embodiment of a rotor according to the present invention;

FIGS. 7 to 11 and 16 are schematic views of a first embodiment of a rotor winding assembly according to the present invention;

FIG. 12 is a second embodiment of a rotor winding assembly according to the present invention;

FIG. 13 is a third embodiment of a rotor winding assembly according to the present invention;

FIG. 14 is a fourth embodiment of a rotor winding assembly according to the present invention;

FIG. 15 is a fifth embodiment of a rotor winding assembly according to the present invention; and

FIG. 16 is a sixth embodiment of a rotor winding assembly according to the present invention.

### DETAILED DESCRIPTION OF SOME EMBODIMENTS

The present invention is generally applicable to both rotary electric motors and rotary electric generators, as these two types of devices generally share a common geometry. The embodiments described below will be directed primarily toward electric motor for a battery powered vehicle, where the motor is structured to provide regenerative braking. In these examples, therefore, the electrical device at issue is used as both an electric motor (during acceleration of the vehicle) and an electric generator (during deceleration of the vehicle).

FIGS. 2 and 3 shows a rotor winding assembly 100 according to the present invention, including rotor 102 and magnet wire winding 104. The magnet wire winding is preferably 18 gauge copper wire, but may be any conductive material suited for winding now known or to be developed in the future. As shown in FIG. 3, rotor 102 has 13 poles and 13 winding support regions located circumferentially (direction indicated by arrow C) around the body of the rotor. Because rotor 102 has an odd number of poles, it is easier to: (1) start the rotor turning (when electric power starts to be delivered through the brush and commutator); (2) maintain rotational motion of the rotor; and/or (3) accelerate rotational motion of the rotor. To the extent that rotors with a an odd number of poles have not previously been employed in rotary electric motors, this feature is an aspect of the present invention.

It is noted that the geometry of rotor 102 is exemplary only. For example, the poles and winding support regions may take on different shapes or profiles. However, rotors according to the present invention will generally have some sort of identifiable circumferential poles and winding support regions. Although there is no absolute requirement that the rotor have a generally circular profile (as shown in FIG. 3), a circular profile is highly preferred because it allows the rotor to maintain close spatial proximity between the outer circumferential edge of the rotor and the stator (not shown), even as it rotates about its central axis A. This proximity is generally important because it helps the magnetic fields of the stator be directed toward and interact with the magnetic fields of the rotor winding, which in turn provides the rotational force to turn the rotor. A circular profile is also preferred because it may help maintain mechanical balance at high rotational speed (e.g., 8000 rpm).

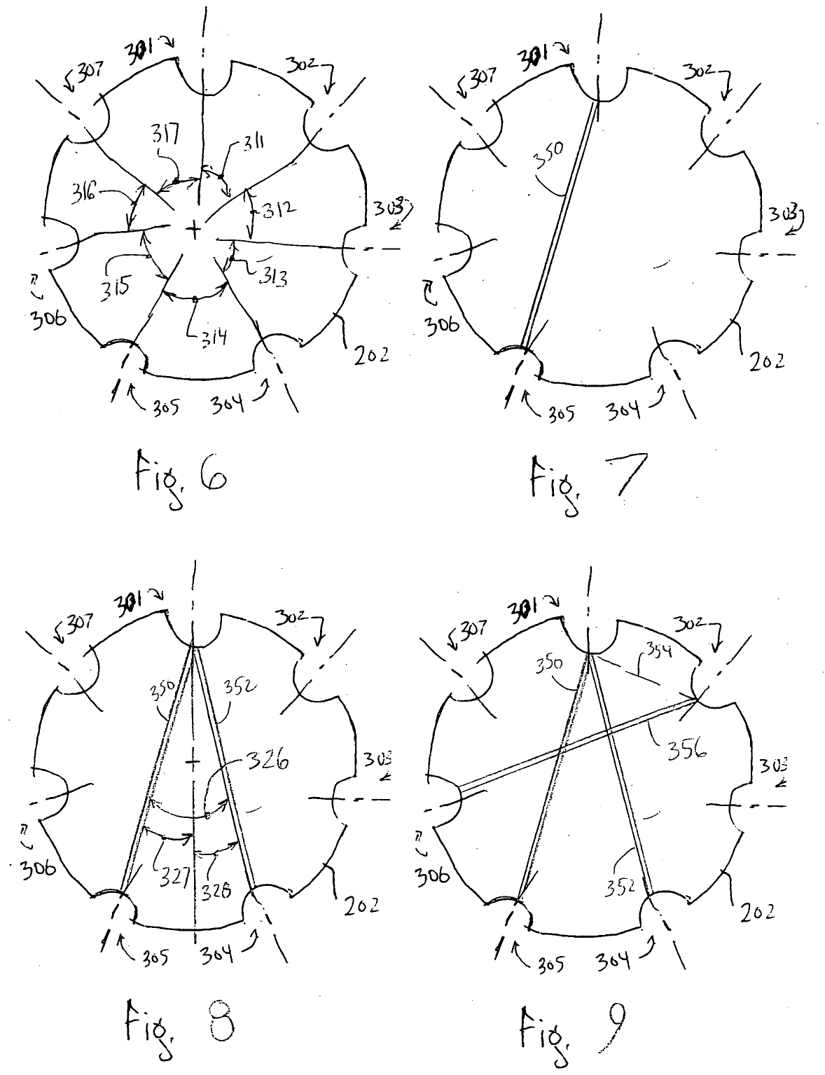

As shown in FIG. 3, winding 104 is in a V-shaped winding pattern (see DEFINITIONS section for a definition of V-shaped winding pattern) in accordance with the present invention. However, the V-shaped winding pattern of FIG. 3 is not necessarily the optimal V-shaped winding pattern because the chords formed by the two legs of the V have unequal angular measurements, which can lead to unfavorable mechanical and/or magnetic imbalances. The V-shaped pattern and some of its preferred and non-preferred variations will be further discussed below in relation to the schematic FIGS. 7 to 16.

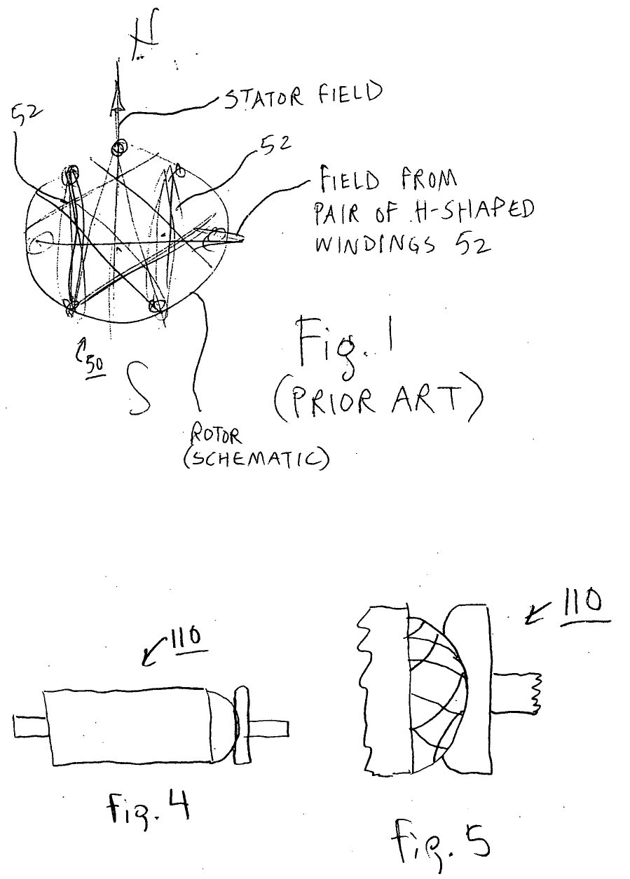

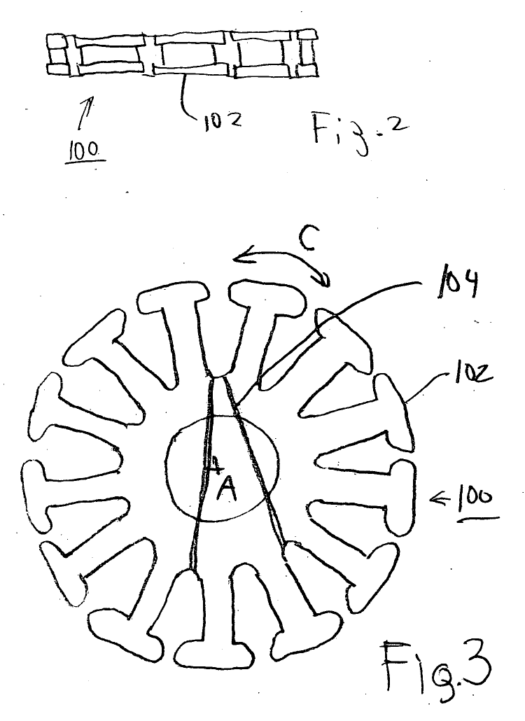

FIG. 4 shows an exterior view of electric motor 110, which includes rotor 102 (not visible from motor exterior) and a V-shaped winding pattern according to the present invention. FIG. 5 shows a portion of a rotary winding having a V-shaped winding pattern 120 according to the present invention.

Before moving on to a discussion of a couple of different embodiments of V-shaped windings, some winding-related terminology will be discussed with reference to FIG. 6. FIG. 6 shows a schematic of 7-pole rotor 202. The rotor includes 7 rotor winding support regions 301, 302, 303, 304, 305, 306, 307. As noted above, the odd number of poles of the rotor has intrinsic performance advantages and this is especially true when the odd pole rotor is would with the V-shaped winding patterns of the present invention. In this exemplary, preferred embodiment, the 7 rotor winding support regions are evenly spaced circumferentially around the circumferential edge of the rotor. Because the rotor has 7 poles, defined by 7 by 7 winding support regions, this means that each of the angles between adjacent winding support regions 311, 312, 313, 314, 315, 316, 317 is equal to 51.4 degrees (that is, 360 degrees/7). In other words, the pole pitch is 51.4 degrees for rotor 202. The following explanation will generally express angles, whether in terms of pole pitch and degrees as being measured in a clockwise direction, in order to eliminate ambiguity concerning the angular measurements discussed. For example, in FIG. 6, there is a 6 pole pitch, or 308.6 degree, angle from rotor winding support region 301 to rotor winding support region 307.

In some of the following explanations, angles will be described using pole pitch as a sort of angular unit. This helps to generalize descriptions of V-shaped windings without specifying the number of poles of the rotor. It may be possible to make rotors according to the present invention with uneven circumferential spacing, but the mechanical and/or magnetic imbalances caused by the irregular polar spacing would need to be addressed in those non-preferred designs.

FIGS. 7 to 11 show the winding of rotor 202 with a preferred V-shaped winding pattern by magnet wire 350, 352, 354, 356, 358, 360, 362, 366, 368, 370. In FIG. 7, the winding is just being started. The double lines of magnet wire 350 represent two loops (see definition of “loop” in the DEFINITIONS section) of magnet wire, with these first two loops being supported and defined by rotor winding support regions 301 and 305. It is noted that this first portion of the rotor winding has two loops, which is the preferred number of loops per leg (see definition of “leg” in the DEFINITIONS section) according to the present invention. As is preferred, each leg 350, 352, 354, 356, 358, 360, 362, 366, 368, 370 of the embodiment of FIGS. 7 to 11 has two loops. In alternative embodiments of the present invention, there may be only one loop per leg, more than two loops per leg, or a varying number of loops per leg. Throughout the Figs., double loop legs are indicated by double lines and single loop legs are indicated by single, solid lines.

At FIG. 8, another leg 352 has been wound between rotor winding support regions 301 and 304. At FIG. 9, the wire has been wound from rotor winding support region 301 to rotor winding support region 302, as indicated by broken line 354. While winding portion 354 is a portion of the rotor winding, it is not a loop or a leg. It is not a loop because it is not wound all the way the rotor body. Rather it is just wound along one axial surface of rotor 202. Winding portion 354 is also not a loop because it does not include at least one loop. The importance of the non-leg, non-loop status of winding portion 354 will become more clear when the definitions and requirements for various types of V-shaped winding patterns are discussed below. In addition to winding portion 354, FIG. 9 also shows that additional leg 356 has now been wound onto rotor 202.

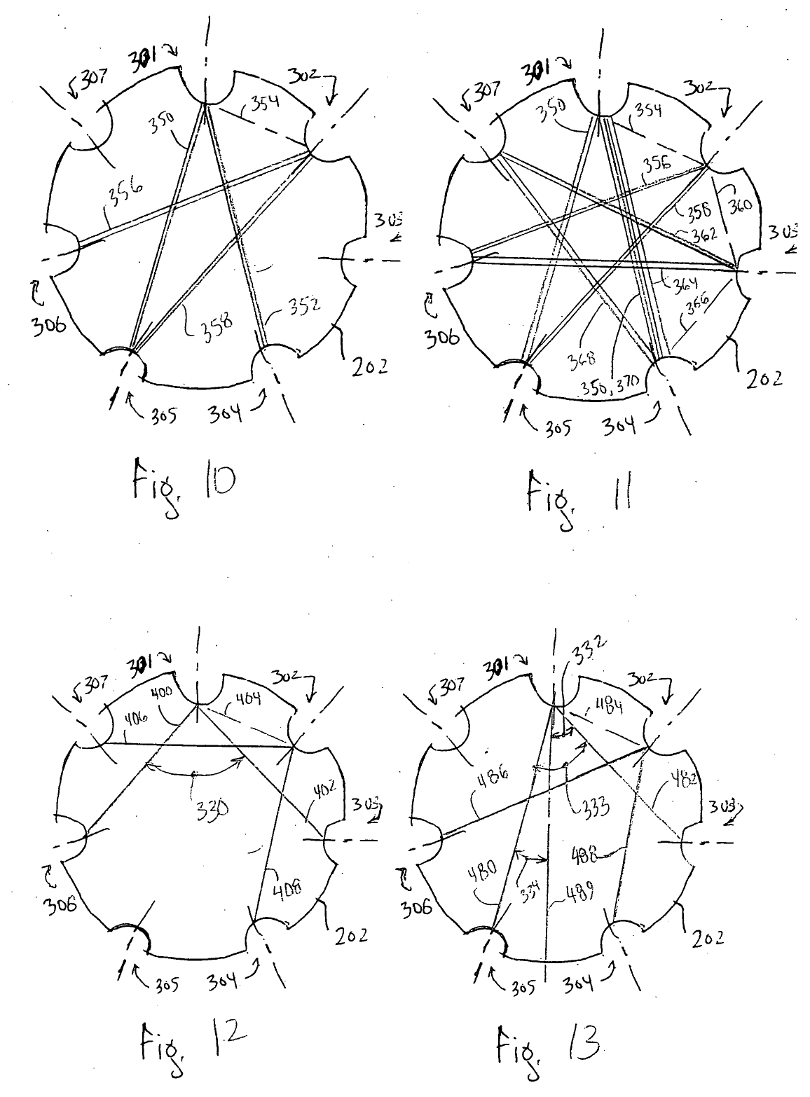

At FIG. 10, additional leg 358 has been wound. At FIG. 11, additional winding portions 360, 366 and legs 362, 364, 368 and 370 have been wound. In this preferred embodiment, the windings are made in the order indicated by their reference numbers, but it is noted that there is some room to vary the order of the windings without really changing the winding pattern. For example, winding 358 could be made before winding 356. Of course, FIG. 11 does not show a complete rotor winding, or at least not a preferred one. This is because there are too few loops and the loops are not at all evenly distributed. However, the pattern indicated by FIGS. 7 to 11 can be continued to build up a large and effective V-shaped rotor winding pattern.

Two features of the FIG. 7 to 11 rotor winding embodiment will now be discussed with reference to FIG. 16. For the sake of simplicity, FIG. 16 shows rotor 202 and only windings 350, 352. FIG. 16 also shows permanent magnets 275, which are part of the stator. Preferably, magnets 275 are curved as shown in FIG. 16. Magnets 275 are set in a North-South orientation so that their associated magnetic field is indicated by flux lines 277. Because rotor 202 has an odd number of poles, this means that most angular positions for rotor 202, the interplay of the rotor magnetic field and stator magnetic field will cause moment forces on rotor 202, which help rotor 202 to start and/or maintain rotation. This makes for a more efficient motor. For example, although the pair of legs 352, 354 are symmetrically placed across the center of the stator's magnetic field 277, it is easy to see that this symmetry disappears very quickly as the rotor is rotated a bit.

Furthermore, solid flux line 330 indicates the direction of the magnetic field associated with rotor winding legs 350, 352. On the other hand, hypothetical, dashed flux line 332 indicates the direction of the field if 350, 352 were consecutive, parallel legs of an analogous, conventional H-shaped rotor winding. As shown in FIG. 16, the angle 342 between hypothetical flux line 332 and the stator magnetic field is a 90 degree right angle, angle 340 between actual flux line 330 and the stator magnetic field is not a right angle. With the hypothetical right angle 342, there is no interplay between the magnetic fields of hypothetical H-shaped legs and the stator. However, the non-right angle 340, there is an angle and this can be conducive to creation of moment forces, directed to help rotate the rotor. In other words, the non-right angle 340 created by legs 350, 352 help rotate the rotor as the rotor is starting to turn and/or as the rotor is in rotation.

There are some important definitional concepts inherent in the preferred winding pattern shown in the embodiment of FIGS. 7 to 11. However, before discussing these definitional concepts, four alternative embodiments of V-shaped winding patterns will be discussed with reference to FIGS. 12, 13, 14 and 15 respectively. These four, less-preferred embodiments will hopefully, helpfully give an idea of the potential variety of V-shaped winding patterns according to various aspects of the present invention (but, caution: these alternative embodiments should not be considered as an exhaustive list of possible embodiments).

In FIG. 12, the winding pattern is made by performing the following winding steps in the following order: (1) wind leg 400 around winding support regions 301 and 306; (2) wind leg 402 around winding support regions 301 and 303; (3) wind portion 404 from winding support regions 301 to region 302; (4) wind leg 406 around winding support regions 302 and 307; (5) wind leg 408 around winding support regions 302 and 304; and (6) repeat according to this pattern. As will be discussed below, FIG. 12 has a greater angle, as measured in pole pitches, between consecutive legs (see definition of “consecutive legs” in the DEFINITIONS section) legs emanating from a single winding support region (e.g., legs 400 and 402 emanate from common region 301) than does the embodiment of FIGS. 7 to 11. It is noted that this wider angle may serve to reduce motor performance somewhat, especially in rotors with a relatively small number of poles, like 7-pole rotor 202.

In FIG. 13, the winding pattern is made by performing the following winding steps in the following order: (1) wind leg 480 around winding support regions 301 and 305; (2) wind leg 482 around winding support regions 301 and 303; (3) wind portion 484 from winding support regions 301 to region 302; (4) wind leg 486 around winding support regions 302 and 306; (5) wind leg 488 around winding support regions 302 and 304; and (6) repeat according to this pattern. As will be discussed below, FIG. 13 lacks symmetry between consecutive legs emanating from a single winding support region (e.g., legs 400 and 402 emanate from common region 301). Specifically, in this embodiment, there is no symmetry about axis 489 as shown in FIG. 13. It is noted that this lack of symmetry may make it more difficult to magnetically and/or mechanically balance the rotor winding assembly.

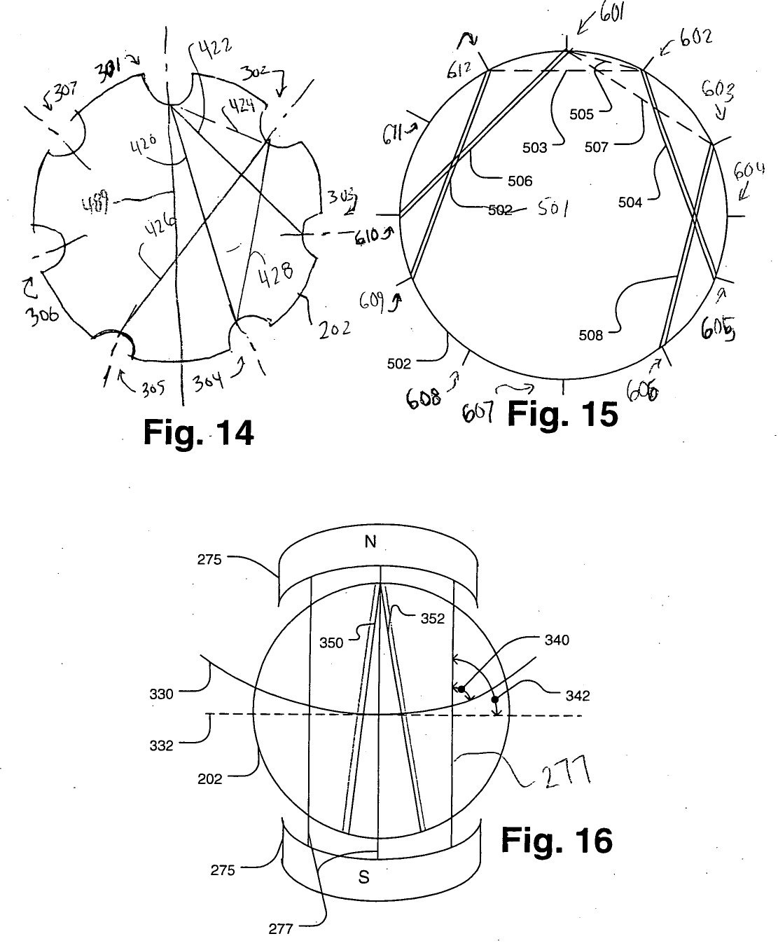

In FIG. 14, the winding pattern is made by performing the following winding steps in the following order: (1) wind leg 420 around winding support regions 301 and 304; (2) wind leg 422 around winding support regions 301 and 303; (3) wind portion 424 from winding support regions 301 to region 302; (4) wind leg 426 around winding support regions 302 and 305; (5) wind leg 428 around winding support regions 302 and 304; and (6) repeat according to this pattern. Like the FIG. 13 winding embodiment, the FIG. 14 embodiment lacks symmetry and care must be taken to avoid magnetic and/or mechanical balance problems.

It is noted that the potential drawbacks of the FIG. 12 to 14 embodiments may be less of a concern in embodiments where the rotor has a greater number of poles (e.g., 13 or more). With respect to the FIGS. 7 to 11 embodiment and the embodiments of FIGS. 12-14, it is noted that the non-leg winding portions (e.g., 354, 360, 366, 404, 484, 424) are all wound in the clockwise direction and all extend between consecutive winding support regions. However, this is not necessarily a requirement of the present invention. Also, it is not a requirement that all non-leg winding portions be placed across a common axial surface of the rotor and winding. However, it is noted that winding portions that form a complete loop are to be considered as legs, rather than non-leg winding portions. This leg/non-leg distinction can have important definitional consequences in understanding at least some aspects of the present invention.

In FIG. 15, 12-pole rotor 502 is used. Rotor 502 includes winding support regions 601 through 612 as shown in FIG. 15. The winding pattern is made by performing the following winding steps in the following order: (1) wind leg 508 around winding support regions 603 and 606; (2) wind portion 507 from region 603 to region 601; (3) wind leg 506 around winding support regions 601 and 610; (3) wind portion 505 from winding support region 601 to region 602; (4) wind leg 504 around winding support regions 602 and 605; (5) wind portion 503 from region 602 to region 612; (6) wind leg 501 around winding support regions 612 and 609; and (6) repeat according to this pattern. It is noted that rotor 502 has an even number of poles. It is also noted, independently of the even polarity of rotor 602, that no two consecutive legs emanate from the same winding support region. However, the embodiment of FIG. 15 is considered to be V-shaped for reasons to be explained below.

Now that the less-preferred embodiments of FIGS. 12 to 15 have been discussed, some definitional concepts related to V-shaped winding patterns will be discussed. First, there is the basic definition of what a V-shaped winding pattern is. As set forth more authoritatively in the DEFINITIONS section, a V-shaped winding is any winding where at least three consecutive legs are all non-parallel to each other. In a conventional H-shaped winding, pairs of winding legs are substantially parallel to each other. Even in H-shaped winding, there is generally an angle between consecutive pairs of legs, but this is different than having three, consecutive mutually-non-parallel legs. Reviewing to FIG. 16 and the related discussion, it should be clear that most, if not all V-shaped windings can potentially have performance advantages over their H-shaped analogs. Notice tat all the embodiments of FIGS. 7 through 15 meet this basic, broad definition of a V-shaped winding patterns. In fact, this would be true even if subsequent windings on these embodiments evinced an H-shaped pattern.

Although V-shaped winding patterns and odd polarity of the rotors are conceptually separable issues, it is noted that V-shaped winding patterns work especially well, perhaps even synergistically, with odd polarity rotors. This is because the V-shaped pattern makes it much easier to magnetically and mechanically balance the rotor winding assembly. This is especially important for assemblies designed to rotate at high speeds (e.g., 8000 rpm). In other words, V-shaped windings can make it much easier to work with odd polarity rotors. This is an important feature of some aspects of the present invention. Of course, the embodiments of FIGS. 7 through 14 are V-shaped winding patterns on odd polarity rotors. The 12-pole FIG. 15 embodiment is not.

Preferred V-shaped winding patterns also have what will be called common winding support regions. This means that at least some of the consecutive legs share a common winding support region. Common winding support regions may be a feature of some conventional H-shaped winding patterns, but it can be especially advantageous to combine this feature with a V-shaped winding pattern. For example, in the embodiments of FIGS. 7 to 14, region 301 is always used as a common winding support region. However, in FIG. 15, there are no common winding support regions.

Remaining focused on embodiments with common winding support regions, FIG. 12 shows that consecutive legs emanating from a common support region may respectively extend to other support regions that are more than one pole pitch apart (e.g., legs 400 and 402 extend to regions 306 and 303, respectively, which is a three pole pitch separation). However, it is usually preferable to minimize the angle between consecutive legs, or at least consecutive legs emanating from a common winding support region. It is especially non-preferred to have legs extending between circumferentially consecutive winding support regions, and some aspects of the present invention may even disallow this. In embodiments where there are common winding support regions, it is generally preferable to have the associated legs extend in opposite angular directions from an axis defined by the common winding support region and the central axis of the rotor. As shown in FIG. 13 (see legs 480, 482 and axis 489), this feature may be present even in some embodiments that are not symmetrical about this axis. FIG. 14 shows an embodiment that is not symmetrical about the axis and where the consecutive legs are both located on the same side of the axis (see FIG. 14 at legs 420, 422 and axis 489).

Many variations on the above-described embodiments of this invention are possible. The fact that a product or process exhibits differences from one or more of the above-described exemplary embodiments does not mean that the product or process is outside the scope (literal scope and/or other legally-recognized scope) of the following claims.

Definitions

The following definitions are provided to facilitate claim interpretation and claim construction:

Present invention: means at least some embodiments of the present invention; references to various feature(s) of the “present invention” throughout this document do not mean that all claimed embodiments or methods include the referenced feature(s).

Circumferential edge: It is noted that “circumferential edges” of rotors are usually not continuous edges, for at least the reason that rotor winding support regions usually involve the formation of discontinuities in the circumferential surface of a rotor.

Consecutive legs: Legs located consecutively in a winding of magnet wire; the legs may be separated by non-leg portions of the magnet wire; if the legs contain more than one loop, then the “consecutive legs” may overlap within the winding.

Electric motor: any motor actuated by an electrical energy source of any design now known or to be developed in the future; for example, a motor for a conventional electric vehicle, running on electricity from batteries, capacitors and/or fuel cells would be one example of an electric motor.

Leg: a section of magnet wire including at least one loop around two rotor winding support regions; generally the loops of a multiple loop leg will be located immediately adjacent to each other with respect to the constituent magnet wire, but the loops must be at least in close proximity with respect to the magnet wire, separated by no more than the length of a couple of loops on the constituent magnet wire (see definition of “consecutive legs”).

Loop: a portion of magnet wire that substantially encircles a portion of a rotor between two winding support regions.

Rotor winding support region: preferably a rotor winding support region is some type of depression or notch in the circumferential edge of a rotor; however, this term includes all structures, built into rotors that prevent the magnet wire winding from substantial angular displacements, now known or to be developed in the future.

V-shaped winding pattern: pattern of magnet wire winding wound wherein at least three consecutive legs of the winding are all mutually non-parallel to each other.

To the extent that the definitions provided above are consistent with ordinary, plain, and accustomed meanings (as generally shown by documents such as dictionaries and/or technical lexicons), the above definitions shall be considered controlling and supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally shown by dictionaries and/or technical lexicons), in the situation where a word or term used in the claims has more than one alternative ordinary, plain and accustomed meaning and the specification is actually helpful in choosing between the alternatives.

What is claimed is:

1. A rotor winding assembly structured for used in a rotary electric motor, the assembly comprising:
a rotor defining a circumferential edge and N rotor winding support regions located along the circumferential edge, wherein N is an odd integer greater than 4; and
magnet wire wound around at least some of the rotor winding support regions.

2. The assembly of claim 1 wherein:
the magnet wire forms a plurality of loops around the rotor; and
all of the loops of the plurality of loops extend between non-circumferentially-consecutive rotor winding support regions.

3. A rotor winding assembly structured for used in a rotary electric motor, the assembly comprising:
a rotor defining a central axis, circumferential edge and N rotor winding support regions located along the circumferential edge, wherein N is an integer greater than 4; and
magnet wire winding wound around at least some of the rotor winding support regions, wherein:
the winding comprises a plurality of legs, and
at least three consecutive legs of the plurality of legs are all mutually non-parallel to each other.

4. The assembly of claim 3 wherein N is an odd integer.

5. The assembly of claim 4 wherein N is greater than 12.

6. The assembly of claim 3 wherein every set of three consecutive legs of the plurality of legs are all mutually non-parallel to each other.

7. The assembly of claim 6 wherein each leg of the winding shares a common rotor winding support region with at least one consecutive leg.

8. The assembly of claim 7 wherein each pair of consecutive legs that share a common rotor winding support region are symmetrically, angularly disposed about an axis defined by the common rotor winding support region and the central axis.

9. The assembly of claim 8 wherein for each pair of first and second consecutive legs that share a common rotor winding support region:
the first leg extends to another rotor winding support region that is (N/2)+0.5 pole pitches, measured clockwise, from the common rotor winding support region; and
the second leg extends to another rotor winding support region that is (N/2)−0.5 pole pitches, measured clockwise, from the common rotor winding support region.

10. The assembly of claim 7 wherein for each pair of first and second consecutive legs that share a common rotor winding support region:
the first leg extends to another rotor winding support region that is more than N/2 pole pitches, measured clockwise, from the common rotor winding support region; and
the second leg extends to another rotor winding support region that is less than N/2 pole pitches, measured clockwise, from the common rotor winding support region.

11. The assembly of claim 3 wherein at least one leg of the winding comprises at least two loops.

12. The assembly of claim 11 wherein all legs of the winding are made up of two loops.
